(19) United States
(12) Patent Application Publication
(10) Pub. No.: US 2009/0006924 A1
(43) Pub. Date: Jan. 1, 2009

(54) FAST DECODING METHOD FOR LOW DENSITY PARITY CHECK (LDPC) CODE

(76) Inventor: Chia-Lu Ho, Jhongli City (TW)

Correspondence Address: HDSL, P.O. BOX 220746, CHANTILLY, VA, 20153-0746, US

(21) Appl. No.: 11/838,970

(22) Filed: Aug. 15, 2007

(30) Foreign Application Priority Data
Jun. 27, 2007 (TW) 096123314

(51) Int. Cl. G06F 11/10

(52) U.S. Cl. 714/758; 714/E11.032

(57) ABSTRACT

A fast decoding method for low density parity check (LDPC) code obtains a block from the information received by a digital communication system, and computes the information of a bit node and a check node by a simplified method, and determine the actual value of the bit node from the logarithm likelihood ratio (LLR) estimated value of each bit node. The simplified method of the invention provides a more effective simplified circuit and a faster computation speed than the traditional functions while maintaining the same error code rate as that before the simplification.

### FIELD OF THE INVENTION

The present invention relates to a decoding method, and more particularly to a simplified decoding method for low density parity check (LDPC) code that can improve computation speed by using the message passing (MP) algorithm.

### BACKGROUND OF THE INVENTION

Forward error correction (FEC) decoding methods such as the Hamming, BCH, Reed Solomon (RS), and turbo codes are used extensively in the industry. However, the level of complexity of these traditional decoding methods increases exponentially with code length. The low density parity check (LDPC) code plays an important role in a digital communication system mainly because its coding/decoding techniques can achieve excellent performance that approaches the Shannon limit.

The coding/decoding theory proposed by Claude E. Shannon in 1948 shows that each Gaussian noise channel has a capacity, and a codeword error caused by such a channel noise can be reduced to arbitrary desired level if the data in the digital communication system is encoded appropriately and the code rate of the codeword is smaller than the channel capacity.

In 1962, Robert G. Gallager proposed a simple structured parity check code, which is known as the low density parity check (LDPC) code due to its sparse parity check matrix. This method, however, did not catch much attention at that time. Until 1981, Michael Tanner graphically specified the low density parity check (LDPC) code by a bipartite graph according to a graph theory with a sum-product message passing algorithm. In 1997, David J. C. MacKay and Radford M. Neal rediscovered the low density parity check (LDPC) and obtained an outstanding result that approaches the Shannon limit.

In addition, the structure of LDPC code is simpler than that of turbo code. Unlike a traditional sequential method that has to wait till all stages of the computation are completed, the decoding of a LDPC code adopts a recurrent parallel processing method, which can be stopped at anytime to obtain a solution. Moreover, some part of the algorithm of this decoding method simply uses addition operations making the calculation much faster than the traditional ones.

A low density parity check (LDPC) code can be represented in terms of a parity check matrix H, which is used to be converted a generating matrix G To generate a codeword, we multiply a raw information vector X with the generating matrix G to yield GX=C. The codeword C should satisfy the constraint CH^{T}=0, otherwise errors had incurred in the transmission of the codeword C. And such errors should be corrected at the receiver decoding stage.

The parity check matrix H is a m×n matrix that treats each row of the matrix H as a check node, and each column as a bit node. Therefore, there are m check nodes and n bit nodes.

The traditional low density parity check (LDPC) algorithm calculates the message uₘ^{(k)}→n sent from the check node m to the bit node n in the k-th recursion as follows:

$$\begin{matrix}{u}_{m \to n}^{( k )} = - sf ( {\sum }_{i ∈ N ( m ) \backslash n} f ( \vert {d}_{m ← i}^{( k - 1 )} \vert ) ) & ( 1 ) \\ {u}_{m \to n}^{( k )} \approx - s {min}_{i ∈ N ( m ) \backslash n} \vert {d}_{m ← i}^{( k - 1 )} \vert & ( 2 ) \\ {u}_{m \to n}^{( k )} \approx - α s {min}_{i ∈ N ( m ) \backslash n} \vert {d}_{m ← i}^{( k - 1 )} \vert , 0.8 \leq α \leq 1 , \\ {u}_{m \to n}^{( k )} \approx s max ( {min}_{i ∈ N ( m ) \backslash n} \vert {d}_{m ← i}^{( k - 1 )} \vert - β , 0 ) , β > 0 , \\ where \\ s = Π sign ( - {d}_{m ← i}^{( k - 1 )} ) and f ( x ) = - ln tanh ( x / 2 ) . & ( 3 )\end{matrix}$$

Equation (2) is called a min-sum approximation, which has the drawbacks of loss of information and compensation issue. In Equation (3) two correction α and β terms have been added to Equation (2). After a recursion has been taken place, the logarithm likelihood ratio (LLR) representing the message produced at the n^{th} bit node is λₙ^{(k)} given by

$${λ}_{n}^{( k )} = \frac{2}{{σ}^{2}} {r}_{n} + {\sum }_{m ∈ M ( n )} {u}_{m \to n}^{( k )} ,$$

where σ² is the variance of a Gaussian channel noise, the value σ of its square root is the standard deviation of the channel Gaussian noise, rₙ is the value of the n^{th} sample in the received sample vector r=[r₁, . . . , rₙ, . . . , r_{N}], and N is the length of the codeword. Here the sign of the logarithm likelihood ratio (LLR) of the estimated value is used for determining whether or not the value of each bit node is 1 or 0.

### SUMMARY OF THE INVENTION

Because of the traditional low density parity check code (LDPC) decoding method implements a complicated function f(x)=−ln tan h(x/2), the inventor of the present invention based on years of experience developed and designed a fast decoding method for the low density parity check (LDPC) code.

It is a primary objective of the present invention to provide a fast low density parity check (LDPC) decoding method, such that when a check node is calculated, the following simplified mathematical function can be used for the calculation:

f(x)=1/x, or f(x)=3.5 e^{-x}.

The simplified mathematical function reduces the level of complexity and computation time of the traditional low density parity check (LDPC) decoding method for calculating f(x)=−ln tan h(x/2) while the error rate (BER) has incurred no significant increase. For the design and manufacturing technology of integrated circuits advance, LDPC code has become a practical one for both theoretical and commercial applications. Furthermore, the LDPC code can be used together with the fast low density parity check (LDPC) decoding method in accordance with the invention to achieve the high-speed, high-capacity and high-reliability effects.

To make it easier for our examiner to understand the value of the invention, its structure, innovative features, and performance, we use a preferred embodiment together with the attached drawings for the detailed description of the invention.

### BRIEF DESCRIPTION OF THE DRAWING

FIG. 1 is a flow chart of a decoding method of the present invention;

FIG. 2 shows a comparison between a simplified function of the invention and a traditional function; and

FIG. 3 shows simulated results of a simplified function of the invention and a traditional function.

### DETAILED DESCRIPTION OF THE PREFERRED EMBODIMENTS

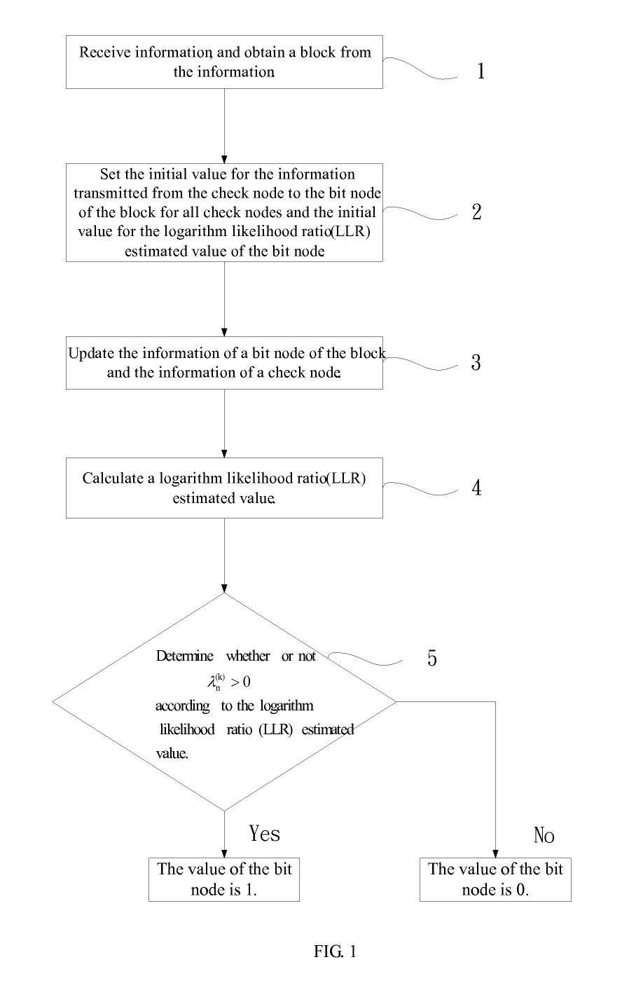

The present invention relates to a fast decoding method for low density parity check code (LDPC), and the decoding method can be applied to cable, wireless and optical fiber communications having an error-tolerance decoding system, an IC decoding algorithm or a data storage and recovery that require a highly reliable decoding algorithm. Referring to FIG. 1 for a flow chart of a decoding procedure of the present invention, the procedure comprises of the following steps:

Step 1: Receive information, and obtain a block from a codeword block of the information;

Execute a message passing (MP) algorithm, which comprises the following steps:

Step 2: Set the initial value uₘ⁽⁰⁾ₙ=0 for the information transmitted from the check node to the bit node of the block for all check nodes m ε {1, . . . , M} and all bit nodes n ε N(m) connected to the check nodes, and set the initial value

$${λ}_{n}^{( 0 )} = \frac{2}{{σ}^{2}} {r}_{n}$$

for the logarithm likelihood ratio (LLR) estimated value of the bit node of the block for all bit nodes n ε {1, . . . , N}, where σ2 is the Gaussian noise variable in the channel, the value σ of its square root is the noise standard deviation, rₙ is the value of the n^{th} received sample in r=[r₁, . . . , rₙ, . . . , r_{N}] and N is the codeword length;

Step 3: Set the recursion counter k=1, 2, . . . , kₘₐₓ, and the recursion counter can be set at an appropriate number of times as needed. And the recursion method is used to update the information of a bit node of the block,

d_{m←n}^{(k-1)}=λₙ^{(k-1)}−u_{m→n}^{(k-1)},

where d_{m←n}^{(k-1)} is the message sent from the bit node n to the check node m in the (k−1)^{th} recursion;

After the message of the bit node is updated, a simplified mathematical function is used to update the message of the check node, and it is updated by calculating a

$${\sum }_{i ∈ N ( m ) \backslash n} f ( \vert {d}_{m ← i}^{( k - 1 )} \vert )$$

function, and the simplified mathematical function f(x) in the

$${\sum }_{i ∈ N ( m ) \backslash n} f ( \vert {d}_{m ← i}^{( k - 1 )} \vert )$$

function is f(x)=1/x or the f(x)=3.5 e^{-x} function, and the d_{m←i}^{(k-1)} is the message sent from the bit node n to the check node m in the (k−1)^{th} recursion;

Substitute the value of the

$${\sum }_{i ∈ N ( m ) \backslash n} f ( \vert {d}_{m ← i}^{( k - 1 )} \vert )$$

function into the function

$${u}_{m \to n}^{( k )} = f ( {\sum }_{i ∈ N ( m ) \backslash n} f ( \vert {d}_{m ← i}^{( k - 1 )} \vert ) )$$

for a calculation to complete an update of the check node. The function f used in the computation is set to be f(x)=1/x or f(x)=3.5 e^{-x}, such that when the value of u_{m→n}^{(k)} is calculated, the simplified mathematical function acts as a key engine function which can reduce the computation time greatly;

Step 4: After the information of the check node is updated and k times of recursion are calculated, the logarithm likelihood ratio (LLR) message λₙ^{(k)} of the bit node is:

$${λ}_{n}^{( k )} = \frac{2}{{σ}^{2}} {r}_{n} + {\sum }_{m ∈ M ( n )} {u}_{m \to n}^{( k )}$$

Step 5: Determine the message of each bit node as the logarithm likelihood ratio (LLR) value by the following conditions: if the logarithm likelihood ratio (LLR) value λₙ^{(k)} is greater than 0, then the n^{th} bit node is 1, and if the logarithm likelihood ratio (LLR) estimated value λₙ^{(k)} is less than zero, then the n^{th} bit node is 0.

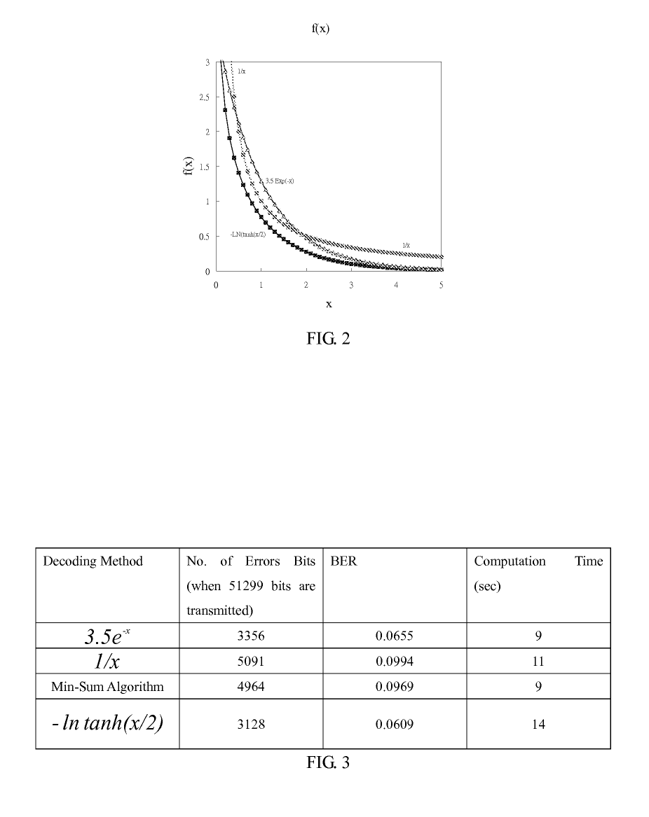

Referring to FIG. 2 for a comparison between the simplified function of the invention and the traditional function, if f(x)=3.5 e^{-x}, then it is closer to the traditional function f(x)=−ln tan h(x/2) than f(x)=1/x, but the computation speeds of both functions are faster than the computation speed of the traditional function. Referring to FIG. 3 for the simulated results of the decoding by the simplified function of the present invention and the traditional function, the simplified function reduces the computation time (by approximately 35%) while BER does not have any significant increase.

The fast low density parity check (LDPC) decoding method of the invention improves the prior art as described below:

1. The simplified function f(x)=1/x or f(x)=3.5 e^{-x} is simpler and easier to implement than the traditional function, and thus the computation time is much reduced.

2. Unlike the min-sum algorithm, the decoding method does not need to find the minimum value before removing other values, and thus there is no concern of losing information or making necessary compensations.

3. The function f(x)=3.5 e^{-x} can avoid round-off errors better than f(x)=−ln tan h(x/2) caused by a limited bit of operations, thus a highly reliable sample value will not be discarded.

It is to be understood, however, that even though numerous characteristics and advantages of the present invention have been set forth in the foregoing description, together with details of the structure and function of the invention, the disclosure is illustrative only, and changes may be made in detail within the principles of the invention to the full extent indicated by the broad general meaning of the terms in which the appended claims are expressed.

What is claimed is:

1. A fast decoding method for low density parity check (LDPC) code, comprising the steps of:
(a) receiving information, and obtaining a block from a codeword in a block of the information;
(b) setting an initial value of a bit node information sent from a check node of the block, and an initial value of a logarithm likelihood ratio (LLR) estimated value of the bit node of the block;
(c) updating the check node information by using a simplified mathematical function, after the bit node information of the block is updated;
(d) calculating a logarithm likelihood ratio (LLR) estimated value of the bit node by the updated check node information, for determining the value of each bit node according to the logarithm likelihood ratio (LLR) estimated value.

2. The fast decoding method for low density parity check (LDPC) code as recited in claim 1, wherein the check node is updated by calculating a
$${\sum }_{i ∈ N ( m ) \backslash n} f ( \vert {d}_{m ← i}^{( k - 1 )} \vert )$$
function first, and a simplified mathematical function of f(x) in the summation
$${\sum }_{i ∈ N ( m ) \backslash n} f ( \vert {d}_{m ← i}^{( k - 1 )} \vert )$$
is a f(x)=1/x function, and at the (k−1)^{th} recursion the message d_{m←i}^{(k-1)} is sent from the bit node i to the check node m; and then the value of the
$${\sum }_{i ∈ N ( m ) \backslash n} f ( \vert {d}_{m ← i}^{( k - 1 )} \vert )$$
function is substituted into another function given by
$${u}_{m \to n}^{( k )} = - s f ( {\sum }_{i ∈ N ( m ) \backslash n} f ( \vert {d}_{m ← i}^{( k - 1 )} \vert ) )$$
for a calculation that updates the check node message, and the simplified mathematical function
$$f ( {\sum }_{i ∈ N ( m ) \backslash n} f ( \vert {d}_{m ← i}^{( k - 1 )} \vert ) )$$
in the other
$${u}_{m \to n}^{( k )} = - s f ( {\sum }_{i ∈ N ( m ) \backslash n} f ( \vert {d}_{m ← i}^{( k - 1 )} \vert ) )$$
function for a calculation that updates the check node message.

3. The fast decoding method for low density parity check (LDPC) as recited in claim 1, wherein the check node is updated by calculating a
$${\sum }_{i ∈ N ( m ) \backslash n} f ( \vert {d}_{m ← i}^{( k - 1 )} \vert )$$
function first, and a simplified mathematical function of f(|d_{m←i}^{k 1)} in the summation
$${\sum }_{i ∈ N ( m ) \backslash n} f ( \vert {d}_{m ← i}^{( k - 1 )} \vert )$$
is a f(x)=3.5 e^{-x} function, and at the (k−1)th recursion the message d_{m←i}^{(k-1)} is sent from the bit node i to the check node m;
and then the value of the
$${\sum }_{i ∈ N ( m ) \backslash n} f ( \vert {d}_{m ← i}^{( k - 1 )} \vert )$$
function is substituted into another function given by
$${u}_{m \to n}^{( k )} = - s f ( {\sum }_{i ∈ N ( m ) \backslash n} f ( \vert {d}_{m ← i}^{( k - 1 )} \vert ) )$$
for a calculation that updates the check node message.

4. The fast decoding method for low density parity check (LDPC) as recited in claim 1, wherein the value of each bit node is determined by a condition that if a logarithm likelihood ratio (LLR) estimated value is greater than zero, then the n^{th} bit node is 1, and if the logarithm likelihood ratio (LLR) estimated value is less than zero, then the n^{th} bit node is 0.
